(19) United States
(12) Patent Application Publication
(10) Pub. No.: US 2013/0007666 A1
(43) Pub. Date: Jan. 3, 2013

(54) ELECTRONIC DEVICE WITH TOUCH SCREEN DEVICE, METHOD OF MOVING FUNCTION ICON AND COMPUTER READABLE STORAGE MEDIA COMPRISING COMPUTER EXECUTABLE INSTRUCTIONS

(75) Inventors: WEI SONG, Shenzhen City (CN); XIAO-GUANG LI, Shenzhen City (CN); HAN-CHE WANG, Tu-Cheng (TW); MING-TSUNG CHEN, Tu-Cheng (TW)

(73) Assignees: HON HAI PRECISION INDUSTRY CO., LTD., Tu-Cheng (TW); HONG FU JIN PRECISION INDUSTRY (ShenZhen)CO., LTD., Shenzhen City (CN)

(21) Appl. No.: 13/279,341

(22) Filed: Oct. 24, 2011

(30) Foreign Application Priority Data
Jun. 28, 2011 (CN) 201110176615.6

(51) Int. Cl. G06F 3/048

(52) U.S. Cl. 715/835

(57) ABSTRACT

An electronic device with a touch screen device selectively displaying one of a plurality of desktop screens is disclosed. Each desktop screen includes function icons and page icons associated with desktop screens. The electronic device further includes a function icon sensing module, a function icon moving module, a page icon sensing module and a page flipping module. The function icon sensing module senses touch on the function icons. The function icon moving module moves the function icon when an icon move operation has been performed. The page icon sensing module senses the touch on a page icon. The page flipping module controls the touch screen device to display a desired desktop screen associated with the selected page icon and add the selected function icon to the desired desktop screen. A method of moving function icon and one or more computer readable storage media comprising computer executable instructions are also disclosed.

### BACKGROUND

1. Technical Field

The present disclosure relates to an electronic device with a touch screen device, a method of moving function icons and one or more computer readable storage media comprising computer executable instructions.

2. Description of Related Art

Electronic devices typically include many function icons representing application programs. Generally, the function icons cannot be wholly displayed on one page because of the limited display area of the electronic device, thus the function icons should be displayed on a number of pages. When there is a need to move the function icon from a current page to another page, a user has to drag the function icon across one page or several pages, which is inconvenient.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a schematic view of an electronic device, according to an exemplary embodiment.

FIG. 2 is a block diagram of the electronic device of FIG. 1.

FIG. 3 is a flowchart of a method of moving function icons of the electronic device of FIG. 1, according to an embodiment.

### DETAILED DESCRIPTION

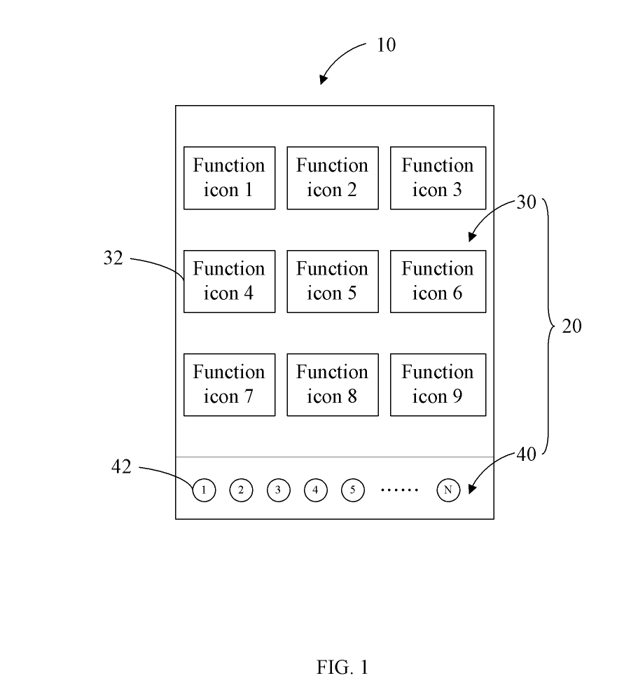

Referring to FIG. 1, an electronic device 10 according to an exemplary embodiment includes a touch screen device 20. The touch screen device 20 displays desktop screens, each desktop screen includes a function icon area 30 and a page icon area 40. The function icon area 30 displays function icons 32 associated with application programs. The page icon area 40 displays page icons 42 associated with the corresponding desktop screens. In the exemplary embodiment, when all of the function icons 32 cannot be displayed on one desktop screen, the function icons 32 can be displayed via a number of desktop screens.

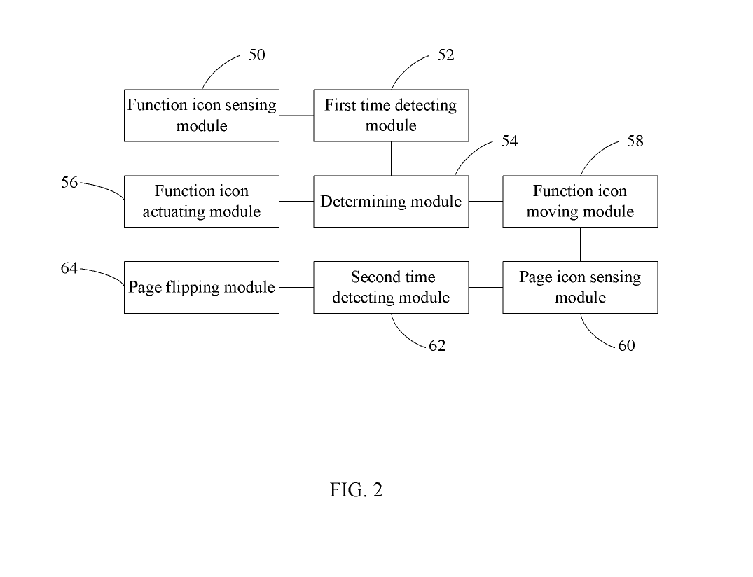

Referring to FIG. 2, the electronic device 10 includes a function icon sensing module 50, a first time detecting module 52, a determining module 54, a function icon actuating module 56, a function icon moving module 58, a page icon sensing module 60, a second time detecting module 62 and a page flipping module 64.

When the function icon sensing module 50 senses a touch on a selected one of the function icons 32 by a user. The first time detecting module 52 detects a time period of the touch on the selected function icon 32 and determines whether the time period on the selected function icon 32 is equal to or longer than a first preset time period. If the time period on the selected function icon 32 is less than the first preset time period, the determining module 54 determines that the touch on the selected function icon 32 is an icon click operation, and responding to the icon click operation, the function icon actuating module 56 actuates the application program which the selected function icon 32 associated with. If the time period on the function icon 32 is equal to or longer than the first preset time period, the determining module 54 determines that the touch on the selected function icon 32 is an icon move operation, and responding to the icon move operation, the function icon moving module 58 actuates the selected function icon 32 into a movable state and further moves the selected function icon 32 following a drag operation on the desktop screen.

The page icon sensing module 60 is configured for sensing if the touch on the selected function icon 32 is moved onto one of the page icons 42. When the touch on the selected function icon 32 is moved onto one of the page icons 42, the page icon sensing module 60 senses a touch on the selected page icon 42. Then the second time detecting module 62 detects a time period of the touch on the a selected page icon 42 and determines whether the time period is equal to or longer than a second preset time period. If the time period on the a selected page icon 42 is equal to or longer than the second preset time period, the page flipping module 64 controls the touch screen device 20 to display a desired desktop screen associated with the touched page icon selected page icon 42 and adds the function icon 32 to the desired desktop screen. If the time period is less than the second preset time period, no page is flipped over and the current page is kept.

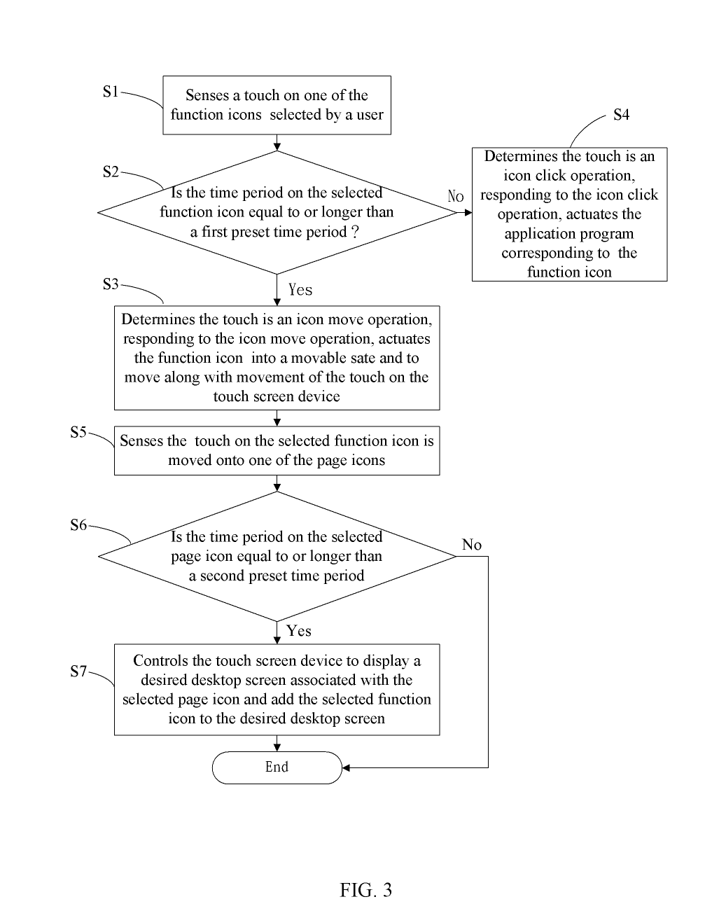

Referring to FIG. 3, a flowchart of a method of moving a function icon 32 of the electronic device 10 is provided.

In step S1, the function icon sensing module 50 senses a touch on one of the function icons 32 selected by a user.

In step S2, the first time detecting module 52 detects a time period of the touch on the selected function icon 32 and determines whether the time period on the selected function icon 32 is equal to or longer than a first preset time period. If the time period on the selected function icon 32 is equal to or longer than the first preset time period, the procedure goes to step S3, otherwise the procedure goes to step S4.

In step S3, the determining module 54 determines the touch is an icon move operation, responding to the icon move operation, the function icon moving module 58 actuates the function icon 32 into a movable sate and to move along with movement of the touch on the touch screen device 20.

In step S4, the determining module 54 determines the touch is an icon click operation, responding to the icon click operation, the function icon actuating module 56 actuates the application program corresponding to the function icon 32.

In step S5, the page icon sensing module 60 senses the touch on the selected function icon is moved onto one of the page icons 32.

In step S6, the second time detecting module 62 detects a time period of the touch on the page icon 42 and determines whether the time period is equal to or longer than a second preset time period. If the time period on the page icon 42 is equal to or longer than the second preset time period, the procedure goes to S7, otherwise the procedure ends.

In step S7, the page flipping module 64 controls the touch screen device 20 to display a desired desktop screen associated with the selected page icon 42 and add the selected function icon 32 to the desired desktop screen.

It is to be understood, however, that even though numerous characteristics and advantages of the present disclosure have been set fourth in the foregoing description, together with details of the structure and function of the present disclosure, the present disclosure is illustrative only, and changes may be made in detail, especially in matters of shape, size, and arrangement of parts within the principles of the present disclosure to the full extent indicated by the broad general meaning of the terms in which the appended claims are expressed.

What is claimed is:

1. An electronic device, comprising:
a touch screen device configured to selectively display one of a plurality of desktop screens, each desktop screen comprising a function icon area and a page icon area, the function icon area being configured for displaying function icons associated with application programs, the page icon area being configured for displaying page icons associated with the corresponding desktop screens;
a function icon sensing module configured to sense a touch on a selected one of the function icons by a user;
a function icon moving module configured to actuate the function icon into a movable state if the touch on the selected function icon is determined as an icon move operation;
a page icon sensing module configured to sense if the touch on the selected function icon is moved onto a selected one of the page icons; and
a page flipping module configured to control the touch screen device to display a desired desktop screen associated with the selected page icon and add the selected function icon to the desired desktop screen.

2. The electronic device as described in claim 1, further comprising a time detecting module, wherein the time detecting module is configured to detect a time period of the touch on the selected page icon, if the time period on the selected page icon is equal to or longer than a preset time period, the page flipping module is configured to control the touch screen device to display a desired desktop screen associated with the selected page icon and add the selected function icon to the desired desktop screen.

3. The electronic device as described in claim 1, further comprising a time detecting module, wherein the first time detecting module is configured to detect a time period of the touch on the selected function icon, if the time period on the function icon is equal to or longer than a preset time period, the touch on the selected function icon is determined as the icon move operation.

4. A method of moving a function icon across different desktop screens of an electronic device with a touch screen device, the touch screen device configured to selectively display one of a plurality of desktop screens and each of the desktop screens comprising a function icon area and a page icon area, the function icon area configured to display function icons associated with application programs, the page icon area configured to display page icons associated with the display screens, the method comprising:
sensing a touch on a function icon selected by a user;
actuating the function icon to move along with movement of the touch on the display screen device if the touch on the selected function icon is determined as an icon move operation;
sensing if the touch on the selected function icon is moved onto a selected one of the page icons; and
controlling the touch screen device to display a desired desktop screen associated with the selected page icon and add the selected function icon to the desired desktop screen.

5. The method of moving a function icon as described in claim 4, further comprising:
detecting a time period of the touch on the selected page icon, controlling the touch screen device to display a desired desktop screen associated with the selected page icon and add the selected function icon to the desired desktop screen if the time period on the selected page icon is equal to or longer than a preset time period.

6. The method of moving a function icon as described in claim 4, further comprising:
detecting a time period of the touch on the selected function icon, wherein the touch on the selected function icon is determined as the icon move operation if the time period on the selected function icon is longer than a preset time period.

7. One or more computer readable storage media comprising computer executable instructions to be executed in electronic device with a touch screen device, the touch screen device configured to selectively display one of a plurality of desktop screens and each desktop screens comprising a function icon area and a page icon area, the function icon area configured to display function icons associated with application programs, the page icon area configured to display page icons associated with the pages, the instructions, when executed, implement a method comprising:
sensing a touch on a function icon selected by a user;
actuating the function icon to move along with movement of the touch on the display screen device if the touch on the selected function icon is determined as an icon move operation;
sensing if the touch on the selected function icon is moved onto a selected one of the page icons; and
controlling the touch screen device to display a desired desktop screen associated with the selected page icon and add the selected function icon to the desired desktop screen.

8. The computer readable storage media as described in claim 7, wherein the method further comprising:
detecting a time period of the touch on the selected page icon, controlling the touch screen device to display a desired desktop screen associated with the selected page icon and add the selected function icon to the desired desktop screen if the time period on the selected page icon is equal to or longer than a preset time period.

9. The computer readable storage media as described in claim 7, wherein the method further comprising:
detecting a time period of the touch on the selected function icon, wherein the touch on the selected function icon is determined as the icon move operation if the time period on the selected function icon is longer than a preset time period
